(19) United States
(12) Patent Application Publication
(10) Pub. No.: US 2017/0354170 A1
(43) Pub. Date: Dec. 14, 2017

(54) METHOD FOR PREPARING AND PACKAGING A READY-MADE DISH, AND CORRESPONDING READY-MADE DISH

(71) Applicant: COMPAGNIE GENERALE DE CONSERVE, Vannes Cedex (FR)

(72) Inventor: Stephane Oriere, Locunole (FR)

(21) Appl. No.: 15/545,557

(22) PCT Filed: Dec. 21, 2015
(86) PCT No.: PCT/EP2015/080868

§ 371 Date: Jul. 21, 2017

(30) Foreign Application Priority Data
Jan. 22, 2015 (FR) 1550510

(51) Int. Cl. A23L 3/10; A23L 3/3418; A23L 19/00; A23L 13/00

(52) U.S. Cl. CPC A23L 3/10; A23L 13/06; A23L 3/3418; A23L 19/03; A23V 2002/00

(57) ABSTRACT

A method for preparing and packaging a ready-made dish. The method includes: placing a first food item in a container; placing a second food item in the container in such a way that the second food item is situated above the first food item; placing a sauce or a gravy in the container so that the sauce or the gravy is situated beneath the first food item or mixed with the first food item without being in contact with the second food item before and during the heating process; carrying out the hermetic vacuum sealing of the container; heating the food contents of the closed container, the container remaining without movement during the heating step.

### 1. FIELD OF THE INVENTION

The field of the invention is that of the agro-food industry.

The invention more particularly relates to a method for preparing and packaging a ready-made (or ready-cooked) dish to be consumed preferably when hot.

The invention also relates to a ready-made dish obtained by such a method.

### 2. PRIOR ART

There are several types of packaging and preservation for ready-made (or ready-cooked) dishes.

Canned types of ready-made dishes, packaged in metal cans, contain cooked foods that have undergone high-temperature thermal processing, especially at temperatures of over 110° C. (i.e. sterilization temperatures). These ready-made dishes can be kept for several months at room temperature.

One drawback of this type of packaging or conditioning is that thermal processing heavily degrades the texture, taste and/or color of the products because of the excessive cooking to which they are subjected.

During thermal processing, it is common practice to rotate or shake the packaging so as to optimize the thermal processing.

The ingredients therefore get mixed within together inside the packaging and the contents can suffer heavy deterioration mechanically. When consuming the food in the ready-made dish, the consumer may be surprised or even disappointed by its appearance.

One difficulty with canned foods lies in the fact that it is difficult to sterilize sauce-containing starch foods (or carbohydrates) such as pasta, rice or pulses while preserving the texture of the starch foods. Indeed, it has been observed that when sterilizing starch foods that are in a sauce, these starch foods acquire mass in a way that is especially pronounced when the container is shaken. The same difficulty has been observed with delicate vegetables (such as tomatoes or aubergines for example) and with fish.

To get around this difficulty, it has been proposed to have prepared foods packaged in compartmented trays (for example, incorporating two compartments separated by a fixed partition wall).

One of the compartments is intended, for example, for meat or fish while the other receives the starch foods or vegetables which the consumer can mix together before eating the dish. Ready-made dishes packaged in trays undergo thermal processing at relatively high temperatures, although at lower heat than in the case of canned foods.

The drawbacks of this type of packaging are appreciably the same as those of canned foods, and are related to the deterioration of food items through thermal processing.

There is therefore a need to improve the quality of the ready-made foods available.

Goals of the Invention

The invention is aimed at overcoming these drawbacks of the prior art.

More specifically, it is a goal of the invention to propose a novel ready-made dish that has an excellent visual appearance and well-preserved taste characteristics.

It is another goal of the invention to propose a novel ready-made dish that can be obtained in particularly economical conditions and that is particularly well suited to industrial-scale production.

### 4. SUMMARY OF THE INVENTION

These goals, as well as others that shall appear here below, are achieved by means of a method for preparing and packaging a ready-made dish.

According to the invention, the method comprises the following steps:
placing a first food item in a container;
placing a second food item in said container in such a way that the second food item is situated above said first food item;
placing a sauce or a gravy in said container so that said sauce or said gravy is positioned/situated beneath said first food item or mixed with said first food item without being into contact with said second food item before and during the heating process;
carrying out the hermetic vacuum sealing of said container;
heating the food contents of said closed container, said container remaining without movement during the heating step.

Thus, the invention relates to the field of ready-made dishes that are pasteurized or sterilized, the pasteurization or sterilization being carried out on the food preparation positioned in a container that is hermetically sealed.

The ready-made dish is for example intended for microwave heating or cooking by the consumer.

The approach of the invention relies on a particular order of arrangement of the foodstuffs in the container before and during the heating (sterilization), the closing under vacuum of the filled container and thermal processing in static conditions of the closed container.

More specifically, the container is filled by successive layers or strata so that before (and during) the heating, a sauce or a gravy is placed in the lower part of the container, this sauce or this gravy being separated from the food item that is on top, a starch food for example, by another food item, for example meat.

This technique thus makes it possible for the starch food that is on top not to come into contact with the sauce or the gravy situated at the bottom of the container. In other words, one constraint that arises before and during the heating step lies in the fact that the sauce or gravy and the starch food must not touch each other. Thus, the sauce must be separate and must not come into contact with the food item situated on the top (i.e. the starch food for example).

However, this does not prevent the container from being filled with meat then starch food and finally gravy. Or else in in one alternative the container can be filled with meat, then gravy, and finally the starch food.

The heating then is implemented only when the gravy has flowed by gravity into the bottom of the container and is no longer in contact with the starch food situated on top (the gravy can then be situated beneath the intermediate food item or it can be partly mixed with this food item).

The filled container is then hermetically sealed under vacuum and subjected to heat treatment at a temperature and for a time sufficient to steam cook the starch food (which is therefore in the upper part of the container). The moist cooking of the starch food by means of steam emitted by the sauce or the gravy means that the starch food will not change its nature.

Contrary to the usual practice of shaking the container during thermal treatment so as to optimize such treatment, the method of the invention provides for the container to be static or without movement during the thermal processing.

The constituent elements laid out in successive layers are therefore not mixed with each other and the presentation of the ready-made dish is ultimately satisfactory, resembling that of traditional cuisine.

The organoleptic qualities, especially taste and appearance, of the constituent elements (and especially the starch foods situated on the top) do not deteriorate or hardly deteriorate during the preparation.

The solution of the invention is furthermore simple to implement and its cost is relatively low.

Besides, the method of the invention can be implemented efficiently on an industrial scale.

According to one particular embodiment of the invention, said heating step ensures a sterilization and/or pasteurization of said product.

Depending on the heating temperature applied, it is possible therefore to sterilize and/or pasteurize this product in a static manner.

In the case of pasteurization of a food item (where this product fills a microwavable tray or bowl), the product can be taken to a temperature of over 75° C., especially 80° C. to 100° C. for a given period of time, for example in the range of 3 to 5 minutes, so as to ensure that it has a “use-by” date set at 20 days after thermal processing for example.

Sterilizing a food item (which is put into a can) then makes it possible to extend this “use-by” date to cover a far greater period of time, for example up to one year. This is possible by taking the product to a higher temperature, for example in the range of 120° C. to 125° C., for a duration of 3 to 5 minutes for example.

According to one particular aspect of the invention, said first food item consists of meat, fish or vegetables. According to one particular aspect of the invention, said first food item is pre-cooked before being packaged in said container.

According to one particular aspect of the invention, said second food item consists of a starch food, fish or delicate vegetables.

According to one particular aspect of the invention, said second food item is pre-cooked before being packaged in said container.

According to one particular aspect of the invention, said heating step ensures sterilization and/or pasteurization of said food items.

According to one particular aspect of the invention, said container is a film-sealed tray, bowl or cylinder, or a can.

According to one particular aspect of the invention, the sauce or the gravy is introduced into the container before the introduction of said first food item or else before or after the introduction of said second food item.

The invention also relates to a ready-made dish prepared and packaged according to the method described here above.

Such a ready-made dish is ready to be heated, in order especially to be eaten hot. The food items in such a dish can be heated in a pan, an oven or by microwave.

Such a ready-made dish can be packaged in a tray or a bowl covered with a sealed film (or lid) or else in a metal can which is hermetically sealed by a lid crimped onto the can.

### 5. LIST OF FIGURES

Other features and advantages of the invention shall appear more clearly from the following description of an example of a mode of implementation given by way of a simple illustratory and non-exhaustive example and from the appended drawings of which:

FIG. 1 is a schematic view in section of an example of a food container showing the particular arrangement of the food constituent according to the method of the invention;

FIG. 2 illustrates the main steps of the method according to one embodiment of the invention.

### 6. DESCRIPTION OF ONE POSSIBLE EMBODIMENT FOR IMPLEMENTING THE INVENTION

6.1 Filling the Container

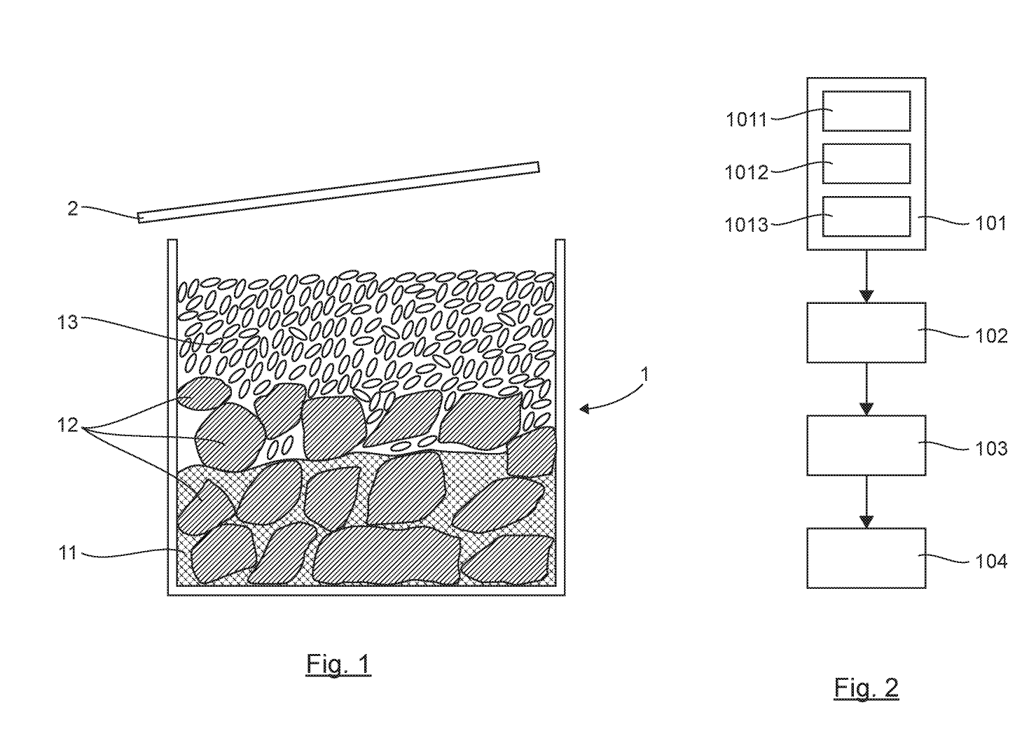

As illustrated in FIGS. 1 and 2, the method for preparing the packaging of a ready-made dish according to the invention consists in filling of single-compartment container 1 which, in this case is a metal can, with successive layers or strata (step 101).

Thus, the method comprises:
the placing of a thick sauce or a gravy at the bottom (down part) of the container 1 (step 1011);
the placing of a topping 12, such as meat, fish and/or pulses which may be raw or pre-cooked (step 1012);
once the topping 12 has been put in place, the placing of a starch food 13 such as rice, pasta or pulses, possibly pre-cooked (step 1013).

The starch food 13 can be packed in last and therefore constitutes the upper element which is to be steamed. The starch food can be replaced any another food item such as fish or certain delicate vegetables that the consumer would like to steam.

It can be noted that the sauce 11 can be added at the end (i.e. once the topping 12 and then the starch food 13 have been placed in the container 1) and can flow by gravity towards the bottom of the container 1. In one alternative the sauce can be added after the topping 12 but before the starch food 13 and can flow by gravity to the bottom of the container 1.

It can be noted that the level of sauce 11 should not touch the starch food 13 during the thermal treatment, since the topping 12 is an intermediate layer between the sauce 11 and the starch food 13. The sauce 11 can be at least partly mixed with the topping 12 as illustrated in FIG. 1.

6.2 Closing the Container

Once the foodstuffs are placed in the container, the container 1 is closed (step 102) by vacuum sealing (i.e. under very low pressure), the value of the vacuum ranging from −500 to −900 mbar. In a classic way, a lid 2 is fixed to the container 1 by crimping.

6.3 Thermal Processing of the Container

The container 1 is subjected to processing in an autoclave to cook (step 103) and if necessary to sterilize the contents (i.e. the food items 11, 12, 13). It is important for the orientation of the container 1 to be kept during the heat processing (step 103) so as to maintain the superimposition of the food items 11, 12, 13.

The cooking causes a rise in pressure inside the container 1, especially because of the evaporation of water from the food items 11, 12, 13 caused by the increase in temperature.

The sauce 11, which is situated in the lower part of the container 1 and does not get mixed with the starch food 13 (because the container 1 is at rest) generates steam which enables the cooking of the starch food 13 situated at the upper part of the container 1 without absorption of liquid.

Such heat processing of food items disposed in the closed container 1 thus prevents volatile substances from escaping from the container 1, which would spoil the final flavor of the ready-made dish. This heat processing furthermore enables homogenous heating of the food items 11, 12 and 13 and optimal preservation of the organoleptic qualities of the constituent elements.

Preferably, the cooking step 103 is followed by a step 104 for cooling the container 1.

The end product (the ready-made dish) thus consists of a sauce 11, a topping 12 and starch foods 13 that are cooked and superimposed in the container 1.

The heating or thermal processing of the product serves especially to promote its preservation. This operation can be a pasteurization (should the food ingredients be placed in a microwavable bowl or tray) or else a sterilization (should the ingredients be placed in a can). In the case of sterilization, the end product is kept at room temperature.

6.4 Other Aspects and Variants

Thus, the combination of an assembly of the food items 11, 12, 13 by layers in the single-compartment container 1, vacuum closure of the container 1 topped with superimposed food items and the cooking/sterilization without movement of the food items in the hermetically sealed container 1 leads to attainment of the goal in view (namely obtaining satisfactory organoleptic qualities for the starch foods 13) through steam cooking of the starch foods 13 in the container 1.

The sauce (or gravy) 11, which is not in contact with the starch food 13 during the heat processing, turns into steam and cooks the starch foods (pasta or rice) 13, which do not lose their nature by wet sterilization.

The method of the invention is particularly suited to ready-made dishes that are canned or else preserved in microwavable trays or bowls closed off with a flexible film that is heat-sealed to the tray or bowl.

Once the container is opened, the consumer can mix the constituents of the dish after or before heating the dish. The heating, done in order to consume the dish, is carried out in a microwave or traditional oven.

The invention can be applied to ready-made dishes comprising food items other than starch foods, especially delicate vegetables or fish.

The duration and cycle of the thermal processing temperatures vary according to the product to be processed and the type of processing in view (pasteurization, sterilization).

Such thermal processing can also be done by means of a microwave field generated by a microwave generator situated outside the container 1, or by induction (for metal cans).

Thus, the method for preparing and packaging a dish prepared according to the invention is simple and costs little to implement, and can be used on an industrial scale.

The method prevents the deterioration of the food item, especially of its organoleptic properties (firmness, texture, flavor), the ready-made dish ultimately having an attractive appearance for the consumer, resembling that of traditional cuisine.

The container can be a metal can or a flexible package such as a semi-rigid cardboard tray or it can be made of semi-rigid plastic material.

The container can have an appreciably rectangular or circular shape for example.

1. A method for preparing and packaging a ready-made dish, wherein the method comprises the following steps:
placing a first food item in a container;
placing a second food item in said container in such a way that the second food item is situated above said first food item;
placing a sauce or a gravy in said container so that said sauce or said gravy is situated beneath said first food item or is mixed with said first food item without being in contact with said second food item before and during the heating;
carrying out the hermetic vacuum sealing of said container; and
heating the food contents of said closed container, said container remaining without movement during the heating step.

2. The method according to claim 1, wherein said first food item is constituted by meat, fish or vegetables.

3. The method according to claim 1, wherein said first food item is pre-cooked before being packaged in said container.

4. The method according to claim 1, wherein said second food item is constituted by a starch food, fish or delicate vegetables.

5. The method according to claim 1, wherein said second food item is pre-cooked before being packaged in said container.

6. The method according to claim 1, wherein said heating step carries out a sterilization and/or a pasteurization of said food items.

7. The method according to claim 1, wherein said container is a tray, bowl or cylinder covered with a sealed film, or a can

8. The method according to claim 1, wherein said sauce or the gravy is introduced into the container before the introduction of said first food item, or else before or after the introduction of said second food item.

9. A ready-made dish obtained according to the method for preparing and packaging according to claim 1.
